(19) United States
(12) Patent Application Publication
(10) Pub. No.: US 2013/0207288 A1
(43) Pub. Date: Aug. 15, 2013

(54) IMPRINTING APPARATUS AND IMPRINTING METHOD

(71) Applicant: Shinji MIKAMI, Kanagawa-ken (JP)

(72) Inventor: Shinji MIKAMI, Kanagawa-ken (JP)

(73) Assignee: KABUSHIKI KAISHA TOSHIBA, Tokyo (JP)

(21) Appl. No.: 13/607,379

(22) Filed: Sep. 7, 2012

(30) Foreign Application Priority Data
Feb. 15, 2012 (JP) 2012-030801

(51) Int. Cl. B29C 59/16

(52) U.S. Cl. 264/40.1; 425/171

(57) ABSTRACT

According to one embodiment, the imprinting apparatus of the embodiment provides an irradiation part, a pattern slippage quantity-detecting part, and a control part. The irradiation part fills the resist, which is dropped as a transfer material on the substrate to be treated, in the template pattern and cures the resist by irradiating the curing light. The pattern slippage quantity-detecting part detects the pattern slippage quantity between the substrate to be treated and the template. The control part controls the irradiation part so as to irradiate intermittently the curing light to each shot and revises the position relation between the substrate to be treated and the template so as to dissolve the pattern slippage between the substrate to be treated and the template based on the pattern slippage quantity detected during stopping of the curing light irradiation.

### CROSS-REFERENCE TO RELATED APPLICATION

This application is based upon and claims the benefit of priority from Japanese Patent Application No. 2012-030801, filed Feb. 15, 2012; the entire contents of which are incorporated herein by reference.

### FIELD

Embodiments described herein relate generally to an imprinting apparatus and an imprinting method.

### BACKGROUND

Nano-imprinting lithography (NIL) is one of the technologies used in the lithography process in the manufacture of semiconductor devices. NIL is a technology utilizing a template having a three-dimensional embossed pattern comprising a plurality of projections and recesses that may be formed by electron beam (EB) writing or lithography, etc. To form a three dimensional pattern on a substrate, the embossed pattern is pressed against a substrate and thereby transfer a three-dimensional reverse image of the embossed pattern of the template onto the substrate.

NIL is carried out by dropping or otherwise forming a photo-curing resin onto a substrate, such as a wafer, and bringing the template into proximity with the substrate to provide contact between the embossed pattern of the template and the photo-curing resin. Then, the photo-curing resin fills in the embossed pattern of the template by capillary phenomenon and under this state, the photo-curing resin is irradiated with UV rays that cure the resin. A three-dimensional reverse pattern corresponding to the embossed pattern of the template is formed on the substrate. The template is then separated from the substrate.

In NIL, sometimes pattern slippage occurs between the template and the substrate to be treated during irradiation of the photo-curing resin with UV rays. Therefore it is desired in NIL to improve the superposition accuracy of the template and the substrate to be treated.

### DESCRIPTION OF THE DRAWINGS

FIG. 1 is a drawing showing the constitution of an imprinting apparatus according to an embodiment.

FIG. 2 is a block diagram showing the constitution of the control device according to an embodiment.

FIGS. 3A to 3D are diagrams explaining the treatment order of the imprinting process.

FIG. 4 is a diagram explaining the measurement of pattern slippage between the template and the wafer.

FIG. 5 is a diagram showing the imprinting sequence by the imprinting apparatus.

FIGS. 6A to 6C are diagrams showing a treatment timing example of exposure, alignment signal detection and pattern slippage revision.

FIGS. 7A and 7B are diagrams explaining the relationship between the imprinting sequence and the pattern slippage quantity.

### DETAILED DESCRIPTION

In general, the imprinting apparatus and imprinting method according to the embodiments are explained in detail by referring to the drawings attached. This disclosure is not limited to the embodiments.

According to the embodiments, there is provided an imprinting apparatus and an imprinting method capable of carrying out precisely the superposition of the template with the substrate to be treated.

According to one embodiment, an imprinting apparatus is provided. The imprinting apparatus is provided with a substrate holding part, a template holding part, an irradiation part, a pattern slippage quantity-detecting part and a control part. The substrate holding part holds the substrate to be treated and also moves the substrate to be treated along the in-plane direction (lateral direction). The template holding part holds a template having a three-dimensional embossed pattern formed thereon and moves the template along the in-plane direction; moreover it moves the template pattern against the resist after a pattern transfer material, such as a resist material, is dropped on the substrate to form a layer of transfer material thereon. The irradiation part irradiates light to cure the resist after the resist is filled into the recesses of the template pattern. The pattern slippage quantity-detecting part detects the quantity of pattern slippage between the substrate to be treated and the desired position of the template with respect to the substrate, and the control part controls at least one of the substrate holding part and the template holding part based on the pattern slippage quantity so as to mitigate the pattern slippage between the substrate to be treated and the template. The control part also controls the irradiation part so as to intermittently irradiate the curing light and also controls at least one of the substrate holding part and the template holding part based on the quantity of pattern slippage detected during the period when irradiation of the curing light is intermittently terminated.

### Embodiment

FIG. 1 is a diagram showing the constitution of an imprinting apparatus 101 according to an embodiment. The imprinting apparatus 101 is an apparatus carrying out imprinting such as nano-imprinting lithography (NIL), etc. The imprinting apparatus 101 transfers template patterns (circuit pattern, etc.) from a template T (master) to a transfer substrate (treating substrate) such as a wafer W, etc. The imprinting apparatus 101 conducts a pattern position inspection or detection step alternately between irradiation of curing light and detection of the alignment signal for each imprint process. The alternate pattern position inspection is performed cyclically so the pattern position inspection will not be influenced by disturbance noise caused by the irradiation of curing light (resist light exposure) on the alignment signal, which is used for alignment between template T and wafer W. In other words, the irradiation of curing light is stopped during detection of the alignment signal so that the alignment signal is not influenced by disturbance noise caused by the irradiation of curing light.

The imprinting apparatus 101 comprises master stage 2, substrate chuck 4, sample stage 5, standard mark 6 (i.e., alignment mark), liquid dropping device 8, stage base 9, UV light source 10, and CCD (charge coupled device) camera 11. Furthermore, the imprinting apparatus 101 has a control device 20.

Wafer W is placed on sample stage 5, and it moves within the plane (horizontal plane) in parallel to the placed wafer W. Sample stage 5 shifts wafer W to the bottom side of the liquid dropping device 8 when resist as, a pattern transfer material, is dropped on wafer W and moves wafer W to face template T prior to affixing the template T for imprint treatment of wafer W.

Further, substrate chuck 4 is installed on sample stage 5. Substrate chuck 4 fixes wafer W at a prescribed position on sample stage 5. Further the standard mark 6 is formed on sample stage 5. Standard mark 6 is a mark for detecting the position of sample stage 5, and it is used for alignment when wafer W is loaded on sample stage 5.

Master stage 2 is installed at the bottom side (wafer W side) of the stage base 9. Master stage 2 fixes template T at a prescribed position from the back surface side (plane on the side where no template pattern is formed) of template T by vacuum adsorption, etc.

Stage base 9 supports template T by master stage 2, and moves the template pattern of template T toward the resist on wafer W. The stage base 9 conducts the pushing of template T against the resist, and pulls the template away from the resist to separate (mold release) the template T from the resist. The resist to be used for imprinting is, for instance, a resist material, such as photo-curable resin (photo-curing agent/chemical solution).

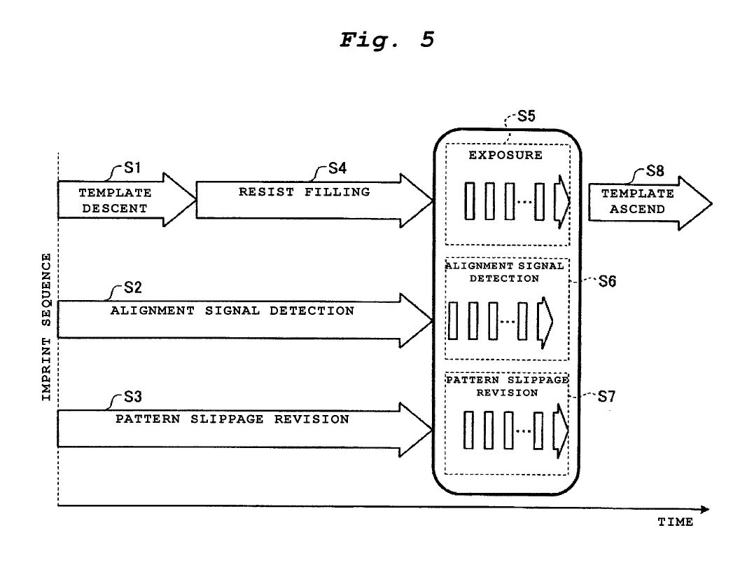

Further, CCD camera 11 is installed on the stage base 9. CCD camera 11 is a camera for detecting the positional relationship between an alignment mark Mt on template T (shown in FIG. 4 and will be explained in detail below) and alignment mark Mw on wafer W (shown in FIG. 4 and will be explained in detail below). CCD camera 11 is installed at the upper part of stage base 9, and it obtains an image of alignment mark Mt and alignment mark Mw through the substantially transparent template T and resist. CCD camera 11 sends the image to control device 20.

Liquid dropping device 8 is a device for dropping resist on wafer W via ink jet mode. The ink jet head (not shown) installed in liquid dropping device 8 has plural fine holes for jetting liquid droplets of resist.

UV light source 10 is a light source for irradiating with UV rays as a resist curing light and is installed on the upper part of the stage base 9. UV light source 10 irradiates UV rays to the upper side of template T, the underside of which is pushed against resist. Furthermore, the curing light may be any light without limitation thereof to UV wavelengths, so long as the light is capable of curing the resist or resin being patterned.

The control device 20 is connected to constituent elements of imprinting apparatus 101 and controls each constituent element. In FIG. 1, control device 20 is connected to sample stage 5, liquid dropping device 8, stage base 9, UV light source 10 and CCD camera 11, and the connections with other constitutional elements is omitted in the drawing. Control device 20 controls UV light source 10, sample stage 5 and stage base 9 during resist curing.

During conducting of imprinting on wafer W, wafer W, placed on sample stage 5, and is then shifted directly below liquid dropping device 8. Then, the resist is dropped on predetermined positions of wafer W (i.e., “shots”). The wafer may also be rotated, or spun, to spread the individual drops from the liquid dropping device 8 into a uniform thin film on the wafer.

Then, wafer W on sample stage 5, is positioned to be below template T, and template T is moved against the resist on wafer W. Control device 20 facilitates contact between template T and the resist until the resist fills in the pattern of template T.

After contacting template T with the resist for a predetermined time, control device 20 controls UV light source 10 to irradiate the resist so that the resist is cured. By this, a negative three-dimensional transfer pattern corresponding to the three-dimensional template pattern is incrementally cured in the resist on wafer W. Then, the imprinting process for the next shot is repeated. By this, imprint processing of all shots on wafer W is carried out to fully cure the resist in one shot curing intervals.

In this embodiment, curing light is intermittently irradiated during curing of the resist within the template pattern, and detection of the alignment signal is carried out when the irradiation of curing light is paused. In other words, detection of the alignment signal is carried out intermittently and irradiation of curing light is stopped when detection of the alignment signal is performed. By this, irradiation of curing light and detection of the alignment signal are carried out alternately (i.e., separately).

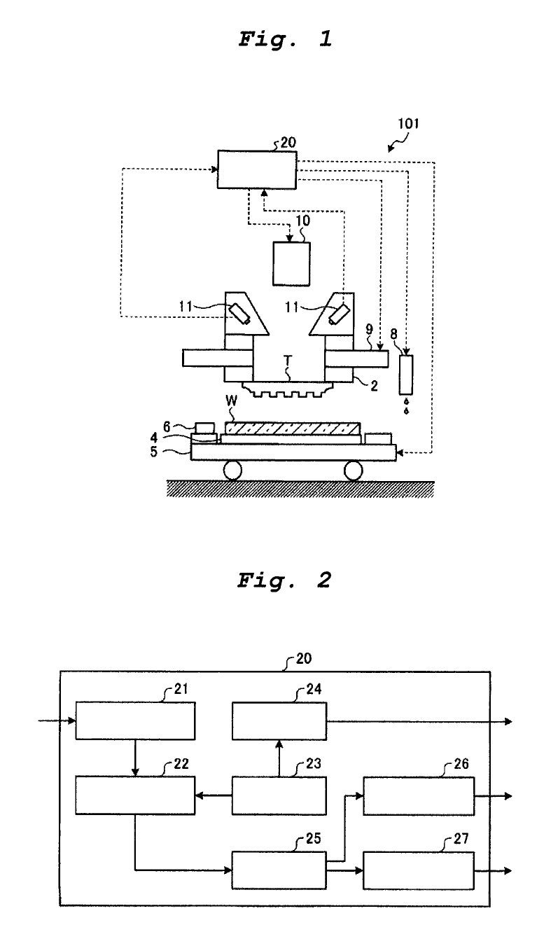

Next, the constitution of control device 20 is explained. FIG. 2 is a block diagram showing the constitution of control device 20 according to an embodiment. Control device 20 has image input part 21, alignment signal detection part 22, timing control part 23, light source control part 24, pattern slippage quantity-detecting part 25, stage base control part 26, and sample stage control part 27.

Image input part 21 sends images of the alignment of mark of Mt with mark Mw (both shown in FIG. 4 and will be explained in detail below) from CCD camera 11 to alignment signal detection part 22. Alignment signal detection part 22 converts the images of alignment mark Mt and Mw to an alignment signal. Alignment signal detection part 22 according to this embodiment intermittently converts images of alignment marks Mt with respect to Mw to a temporal alignment signal based on the instructions from timing control part 23. For example, alignment signal detection part 22 converts images, which are sequenced in time with the order of alignment detection from timing control part 23, among images being sent from image input part 21 to the alignment signal. The alignment signal detection part 22 sends the alignment signal to the pattern slippage quantity-detecting part 25.

Pattern slippage quantity-detecting part 25 detects the positional relationship (pattern slippage quantity) of alignment mark Mt with respect to alignment mark Mw based on the alignment signal. The positional relationship of alignment mark Mt to Mw is a direct indication of the alignment, or misalignment, of template T and wafer W. Pattern slippage quantity-detecting part 25 according to this embodiment detects pattern slippage based on differences in position of the alignment mark Mt and Mw, based on the alignment signal, which is detected by alignment signal detection part 22 based on the order from timing control part 23. Pattern slippage quantity-detecting part 25 sends the pattern slippage revision quantity based on detected pattern slippage quantity to stage base control part 26 and sample stage control part 27.

Pattern slippage quantity-detecting part 25 sends, for instance, the pattern slippage revision quantity, which shifts the position of all shots in parallel, and the pattern slippage revision quantity, which shifts rotationally the position of the shots, etc. to sample stage control part 27. Further, pattern slippage quantity-detecting part 25 sends, for instance, a shot magnification-changing pattern slippage revision quantity that may be applied to all shots.

Timing control part 23 sends to alignment signal detection part 22 a detection instruction for facilitating detection of alignment signal and a detection-stoppage signal to cease detection of alignment signal. Further, timing control part 23 sends to light source control part 24 an irradiation facilitating initiation of curing light and an irradiation-stoppage signal to stop irradiation of curing light.

Timing control part 23 sends a signal detection stoppage order of alignment signal detection to alignment signal detection part 22 during sending of irradiation order to facilitate initiation of curing light to light source control part 24. On the other hand, timing control part 23 sends irradiation stoppage signal to stop irradiation of curing light to light source control part 24 during the sending of the detection signal to facilitate detection of alignment signal to alignment signal detection part 22. By this, one time period of irradiation of curing light and one time period of detection of the alignment signal (pattern slippage quantity) is carried out in imprinting apparatus 101 during curing of the resist filled template pattern.

Light source control part 24 controls UV light source 10. Light source control part 24 irradiates curing light to UV light source 10 when an irradiation initiation order of curing light is received from timing control part 23. On the other hand, light source control part 24 stops irradiation of curing light to the UV light 10 source when the irradiation stop order of curing light is received from timing control part 23.

Stage base control part 26 controls the position of stage base 9 based on the pattern slippage revision quantity sent from pattern slippage quantity-detecting part 25. Stage base control part 26 revises, for instance, the position of stage base 9 so as to make the modification of the shot and resolve pattern slippage errors.

Sample stage control part 27 controls the position of sample stage 5, based on the pattern slippage revision quantity sent from pattern slippage quantity-detecting part 25. Sample stage control part 27 revises, for instance, the position of sample stage 5 so as to make the desired position of a whole shot position (so as to resolve pattern slippage in parallel shifting or rotational shifting).

Timing control part 23, instead of alignment signal detection part 22, may send an order of processing or stoppage at a predetermined time to any part of CCD camera 11, image input part 21, and pattern slippage quantity-detecting part 25. Furthermore, timing control part 23 may send an order of processing or stoppage at a predetermined time to stage base control part 26 and sample stage control part 27.

Pattern slippage revision is carried out based on pattern slippage quantity detected during irradiation stoppage of curing light by sending a processing order to CCD camera 11, image input part 21, alignment signal detection part 22, pattern slippage quantity-detecting part 25, stage base control part 26 and sample stage control part 27 at the time of irradiation stoppage of curing light.

A detection order is sent to pattern slippage quantity-detecting part 25 during irradiation stoppage of curing light L1, for instance, when timing control part 23 sends an order of detection and order of stoppage to pattern slippage quantity-detecting part 25.

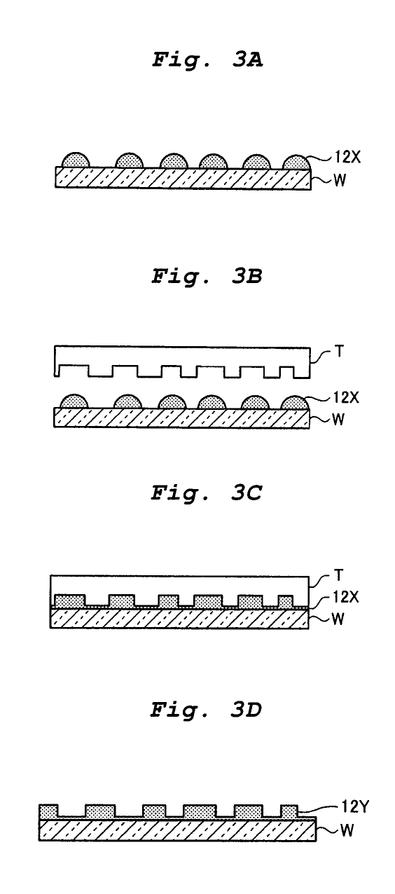

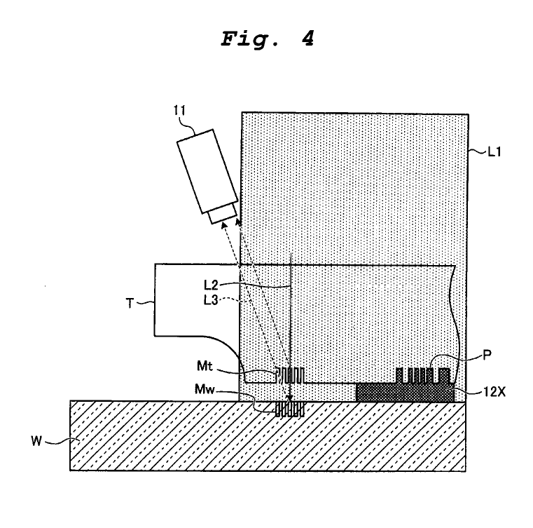

Now, the processing order of the imprinting process is explained. FIGS. 3A to 3D are diagrams explaining the processing order of the imprinting process. FIG. 4 shows a cross-sectional view of the wafer W or template T in the imprinting process.

Resist 12X is dropped on the upper surface of the wafer W as shown in FIG. 3A. Each liquid drop of resist 12X dropped on the wafer W spreads in the wafer W plane. As shown in FIG. 3B, template T is moved toward the resist 12X side, and as shown in FIG. 3C, it is pushed against the resist 12X. Like this, when template T, formed of a quartz substrate, etc., is in contact with resist 12X, resist 12X flows in the template pattern of template T by capillary phenomenon.

After filling resist 12X in template T only for a preset sufficient time, curing light irradiates so that resist 12X is cured. Then, template T is separated from the cured resist pattern 12Y, as shown in FIG. 3D, to form a resist pattern 12Y, reversed from the three-dimensional template pattern, on wafer W.

FIG. 4 is a diagram explaining measurement of pattern slippage between template T and wafer W. A cross-sectional view of template T and wafer W is shown in FIG. 4. After filling resist 12X in template pattern P of template T, curing light L1 is irradiated to resist 12X. At this time, irradiation of curing light L1 to resist 12X is carried out intermittently. In the interval when irradiation of curing light L1 is stopped, pattern slippage between template T and wafer W, which relates to pattern slippage, is detected. Alignment light L2 irradiates the alignment of marks Mt and Mw, and reflection of light L3 from alignment marks Mt and Mw is detected by CCD camera 11. The reflection light L3 detected by CCD camera 11, is forwarded as an image of the alignment of mark Mt with Mw, to control device 20. Then, the pattern slippage between template T and wafer W is revised based on the image of the alignment of mark Mt with Mw.

Next, the imprint sequence by imprinting apparatus 101 is explained. FIG. 5 is a diagram showing the imprint sequence by the imprinting apparatus. When movement of template T towards the wafer W is started (S1) by stage base 9, alignment signal detection part 22 starts detection of the alignment signal (S2). Furthermore, when detection of the alignment signal is started, pattern slippage quantity-detecting part 25 starts detection processing of its pattern slippage quantity and computation processing of its pattern slippage revision quantity. If position slippage is detected, stage base control part 26 executes position revision of stage base 9 based on the pattern slippage revision quantity. Further, sample stage control part 27 starts position revision of sample stage 5 based on the pattern slippage revision quantity. By this, pattern slippage revision between template T and wafer W starts (S3).

After pushing template T against resist 12X, filling of resist 12X is carried out (S4). At this time, alignment signal detection part 22 continues detection of the alignment signal, and pattern slippage quantity-detecting part 25 continues detection processing of the pattern slippage quantity and computation processing of the pattern slippage revising quantity. Further, stage base control part 26 continues position revision of stage base 9 while sample stage control part 27 continues position revision of sample stage 5.

When the filling of resist 12X is completed, intermittent exposure (irradiation of curing light L1) of resist 12X starts with individual discrete shots (S5). Further, between each shot, intermittent detection of alignment signal (S6), and pattern slippage revision between template T and wafer W is begun (S7). When the cumulative number of intermittent exposures of the resist 12X is sufficient to fully cure the resist, the, detection of alignment signal and intermittent pattern slippage revision between template T and wafer W are also terminated. Then, stage base 9 moves to separate template T from resist pattern 12Y (S8).

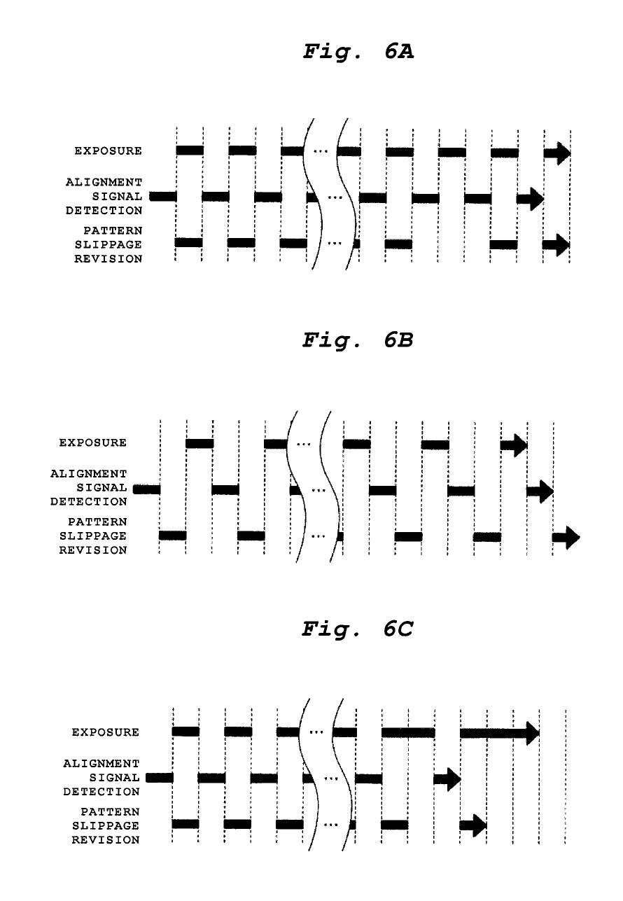

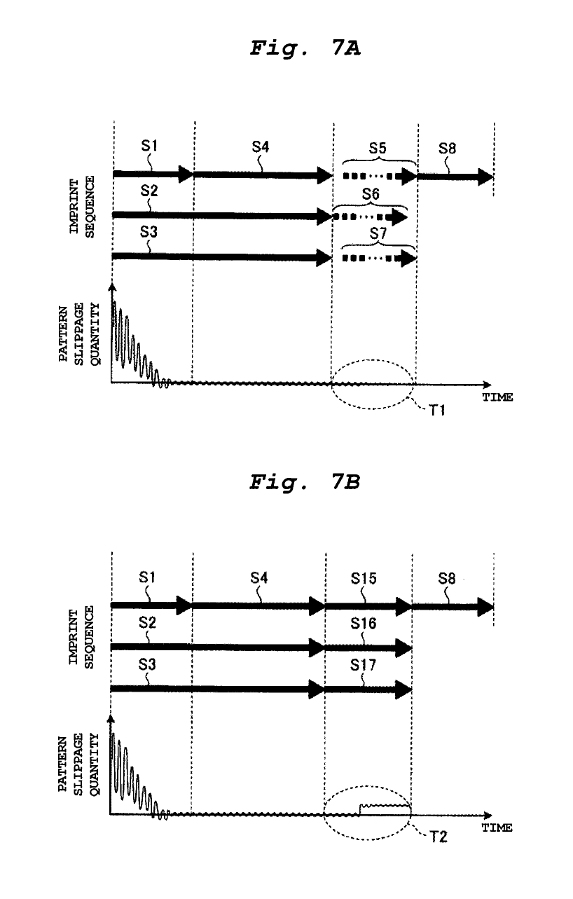

Now, process timing (on/off) of intermittent exposure processing, intermittent detection processing of alignment signal, and intermittent pattern slippage revision processing are explained. FIGS. 6A to 6C are diagrams showing a process timing example of exposure, alignment signal detection and pattern slippage revision. In FIGS. 6A to 6C, on/off timing of each process in one shot is shown. In FIGS. 6A to 6C, smear-away timing (e.g., timing “on”) is used for performing the process, which is indicated by the bolded solid lines/arrows in FIGS. 6A to 6C.

Exposures shown in FIGS. 6A to 6C correspond to exposure (S5) shown in FIG. 5. Similarly, alignment signal detections shown in FIGS. 6A to 6C correspond to alignment signal detection (S6) shown in FIG. 5, and pattern slippage revisions shown in FIGS. 6A to 6C correspond to pattern slippage revision (S7) shown in FIG. 5.

As shown in FIG. 6A to FIG. 6C, exposure (irradiation of curing light L1) repeats on/off at a predetermined timing. Alignment signal detection is carried out during the off cycle (irradiation stoppage of curing light L1) of exposure. Thus, exposure time repeats on/off at a predetermined cycle, and thus alignment signal determination time also repeats on/off at a predetermined interval. The pattern slippage revision between template T and wafer W is carried out during the off state of alignment signal detection. Exposure and pattern slippage revision turn off during the alignment signal detection, and exposure and/or pattern slippage revision turn on when alignment signal detection is off.

In FIG. 6A, pattern slippage revision is performed during exposure, and pattern slippage revision is ceased when exposure is ceased. By this, pattern slippage revision is occurs when the alignment signal detection period is over, and during exposure of the resist to the curing light.

In FIG. 6B, pattern slippage revision is off when exposure is on, and pattern slippage revision is on when exposure is off. Additionally, pattern slippage revision occurs only when the alignment signal is also off. Sequentially, the resist is exposed to a shot of curing light, the alignment is then detected, and then, the pattern slippage revision, if needed, is performed. This sequence repeats, without overlapping any of the three functions in time, until the resist is cured. In FIG. 6C, processing timing of exposure, alignment signal detection and pattern slippage revision is shown in the case when of exposure on-time is longer as exposure after one or more “shots” have occurred. Since curing of resist 12X advances as exposure occurs, it is hard for pattern slippage to occur between template T and wafer W during that time period. Thus, the number of alignment signal detection and pattern slippage revisions may be decreased as the cumulative exposure of the resist increases. Thus, it is possible to shorten the time required for whole exposure processing of the resist since the number of alignment signal detections can be decreased by making longer the on-time of exposure as exposure (and curing) advances.

Like this, imprinting apparatus 101 repeats exposure and stop of exposure one to several times. Then, imprinting apparatus 101 conducts detection of the alignment signal during stopping of exposure. Furthermore, alignment signal detection and pattern slippage revision may be carried out at least once during a period in which the exposure is not occurring.

FIGS. 7A and 7B are diagrams explaining the relationship between imprint sequence and pattern slippage quantity. FIG. 7A shows variation of pattern slippage quantity when exposure and detection of alignment signal are carried out alternately. Further, FIG. 7B shows variation of pattern slippage quantity when exposure and detection of alignment signal are carried out simultaneously.

As shown in FIG. 7A, intermittent exposure (S5) and intermittent alignment signal detection (S6) are carried out by alternately conducting exposure and detection of the alignment signal. Therefore exposure is stopped during alignment signal detection. It is possible by this to suppress the vibration of master stage 2 or sample stage 5 during irradiation of curing light L1, and it is possible to suppress pattern slippage during intermittent exposure period T1. Thereupon, it is possible to carry out accurate alignment signal detection and, as a result, accurate pattern slippage revision can be carried out.

On the other hand, as shown in FIG. 7B, if filling (S4) of resist 12X is completed in the case of simultaneously carrying out exposure and alignment signal detection, continuous exposure (S15), continuous alignment signal detection (S16) and continuous pattern slippage revision (S17) are also carried out. Thereupon, exposure is carried out during alignment signal detection. This causes vibration of master stage 2 or sample stage 5 during irradiation of curing light L1. Therefore, pattern slippage during exposure period T2 is larger in the case of simultaneously carrying out exposure and alignment signal detection than in the case of alternately carrying out exposure and alignment signal detection.

Imprint of alternate exposure and alignment signal detection is carried out in, for instance, each layer of the wafer process. In the production of semiconductor devices (semiconductor integrated circuit), imprint processing of forming film on wafer W and carrying out alternately exposure and alignment signal detection, and etching treatment of resist pattern 12Y formed by imprint processing, etc. are repeated in each layer.

According to the embodiment, it is possible to accurately detect the alignment signal since exposure is stopped during alignment signal detection. Thereupon, pattern slippage revision between template T and wafer W can be carried out accurately and, as a result, it is possible to carry out accurately superposition of template T and wafer W.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A patterning device, comprising:
a template having a surface with a three-dimensional pattern and a first alignment mark formed thereon;
a substrate having a surface with a second alignment mark formed thereon positioned in an opposing relationship to the surface; and
an alignment and exposure system, wherein, when a resist material is located between the surface of the template and the surface of the substrate, and the resist material is cured by applying energy from the exposure system to the resist material, and alignment between the first alignment mark on the template and the second alignment mark on the substrate is inspected during periods when the energy is not applied to the resist material.

2. The device of claim 1, wherein the alignment system further comprises a charge coupled device camera.

3. The device of claim 1, wherein the energy comprises ultraviolet light.

4. The device of claim 1, wherein the alignment system comprises:
a stage configured to hold the substrate;
a template holder, and
a controller coupled to the stage and the template holder configured to correct any misalignment between the template and the substrate.

5. The device of claim 4, wherein the alignment system is configured to correct any misalignment between the template and the substrate during periods when the energy is not applied to the resist material.

6. The device of claim 5, wherein one or both of the stage and the template holder are configured to move to correct the misalignment.

7. The device of claim 1, wherein the substrate is a semiconductor wafer.

8. The device of claim 7, wherein the pattern comprises a plurality of nano-scale protrusions and a plurality of nano-scale depressions.

9. The device of claim 1, wherein the exposure system comprises a light source and the system controls application of light at intermittent and repeating intervals.

10. The device of claim 9, wherein each of the intermittent intervals comprise time periods having unequal lengths.

11. The device of claim 10, wherein the time between the periods when the energy is not applied to the resist increase as the cure rate of the resist material increases.

12. The device of claim 1, wherein a change in the relative position of the first and second alignment marks indicates slippage of the pattern being formed on the substrate with the template.

13. An imprinting method, comprising:
pressing a template pattern formed on a template against a curable material on a substrate;
exposing the curable material to a curing energy source in a plurality of curing time periods to cure the resist material; and
monitoring, in a plurality of monitoring time periods, a first alignment mark located on the template and a second alignment mark located on the substrate, wherein the curing time periods and the monitoring time periods are different time periods.

14. The imprinting method of claim 13, wherein the first alignment mark and second alignment mark are aligned prior to a curing time period;
the alignment between the first and second alignment mark is detected after a curing time period; and
the substrate and template are moved with respect to each other to re-establish the alignment of the template and the substrate which existed prior to the curing time period.

15. The imprinting method of claim 14, wherein the first alignment mark and second alignment mark are imaged by an imaging system, and, prior a curing time period, at least one on the template and the substrate are moved relative to each other to overlay the first and second alignment mark and establish an aligned position between the substrate and the substrate.

16. The imprinting method of claim 15, wherein, after the execution of at least one curing time period, the first and second alignment marks are imaged, and, if a change in relative position of the first and second alignment marks has occurred during the at least one curing time period, the first and second time periods are moved, relative to one another, to reestablish the alignment therebetween which existed prior to the at least one curing time period.

17. The imprinting method of claim 16, wherein the substrate is received on a movable stage, and a controller receives an image of the first and second alignment and provides instruction to at least one of the substrate stage and the template to move the substrate and or the template to realign the substrate and the template where a change in position of the first and second alignment marks has occurred during a curing time period.

18. The imprinting method of claim 17, wherein the movement of the stage and/or movement of the template occurs during the subsequent exposure time period.

19. The imprinting method of claim 17, wherein the movement of the stage and/or movement of the template occurs prior to the subsequent exposure time period.

20. The imprinting method of claim 13, wherein the time during which the curing time period and monitoring time periods occur do not overlap.
